(19) United States
(12) Patent Application Publication
(10) Pub. No.: US 2004/0260947 A1
(43) Pub. Date: Dec. 23, 2004

(54) Methods and systems for analyzing security events

(76) Inventors: Gerard Anthony Brady, Roswell, GA (US); Richard Michael Sears, Woodstock, GA (US)

Correspondence Address: TESTA, HURWITZ & THIBEAULT, LLP, HIGH STREET TOWER, 125 HIGH STREET, BOSTON, MA, 02110, US

(21) Appl. No.: 10/691,428

(22) Filed: Oct. 21, 2003

Related U.S. Application Data
(60) Provisional application No. 60/420,335, filed on Oct. 21, 2002.

(51) Int. Cl. G06F 11/30

(52) U.S. Cl. 713/201

(57) ABSTRACT

In one aspect, the technology relates to a method for analyzing a security event in a distributed fashion. The method includes the steps of detecting an occurrence of a security event within a customer network and querying a first component of the customer network for data in response to the detected occurrence of the security event. The method also includes the steps of receiving, by a data monitor located within the customer network, first data from the component in response to the query and determining, based on the received first data, whether to query for additional data. The method additionally includes querying at least one of the first component and another component of the customer network to obtain the additional data in response to the determining step, and analyzing the security event using at least one of the first data and the additional data.

### CROSS-REFERENCE TO RELATED APPLICATIONS

This application claims priority to U.S. provisional patent application Ser. No. 60/420,335, filed Oct. 21, 2002, and is incorporated by reference herein.

### TECHNICAL FIELD

The present technology relates generally to communicating over a network and, more specifically, to methods and systems for analyzing security events.

### BACKGROUND

In today's global economy, people often communicate over an electronic network, such as the Internet or World Wide Web. This type of communication enables rapid communications over a large distance. Besides the speed and distance advantages, however, the advent of network communications has introduced security-related issues. A breach in the security of an organization's network, for example, can have a large impact on the well-being of the organization's business operations. Moreover, the resolution of a security breach can result in a long delay and/or a large financial burden before operations return to normal.

Security service providers respond to these security risks by offering customers a variety of security-related functions. Many, if not all, of these functions require the security service provider to review data associated with a security event that has occurred in a customer's network. Traditionally, security service providers analyze and review data associated with a singular security event that affected the customer's network. The information relating to a single security event, however, often does not provide enough information to the service provider to make an accurate determination about the security event and future behavior relating to the security event.

To obtain a better determination of the security event, therefore, a security service provider may attempt to analyze additional data. The sampling of data potentially related to the security event, however, can introduce vast amounts of data, too voluminous to provide any meaningful analysis and/or correlation between the data and event.

Further, even if restricting the analysis to data associated with a single security event, a security service provider frequently stores this data in a centralized location, such as a database, for analysis. A centralized data storage system, however, is often difficult to manage. The centralized data storage system also often provides scalability issues—it can only manage a fixed amount of data. Moreover, a centralized data storage system may have the harmful result of the security service provider retrieving stale data, as the centralized data storage is only as current as the last time data was saved.

### SUMMARY OF THE TECHNOLOGY

Thus, there remains a need to increase the scalability and robustness of a security service provider system while ensuring access to data that is current. Furthermore, there remains a need to analyze a large amount of data that may not be directly related to a security event to facilitate a more accurate analysis of the security event.

To solve these shortcomings of the prior art, a security analysis system enables analysis of data in a distributed fashion instead of using a centralized data model. Further, in response to a security event, the security analysis system queries one or more components in a customer's network to obtain data that the security analysis system can use to accurately analyze the security event and recommend a precise technique to resolve the security event to the customer. In particular, the system queries one or more components and, based on the response, generates another more targeted query for the same or different components in the customer's network. This sequence enables a chain of transactional queries to collapse the pool of data to a subset of data that can enable an accurate analysis of the security event.

In one aspect, the technology relates to a method for analyzing a security event in a distributed fashion. The method includes the steps of detecting an occurrence of a security event within a customer network and querying a first component of the customer network for data in response to the detected occurrence of the security event. The method also includes the steps of receiving, by a data monitor located within the customer network, first data from the component in response to the query and determining, based on the received first data, whether to query for additional data. The method additionally includes querying at least one of the first component and another component of the customer network to obtain the additional data in response to the determining step, and analyzing the security event using at least one of the first data and the additional data.

In one embodiment, the determining step includes at least one of intrusion of the customer network, a port scan, service probes, a signature from an attack, a buffer overflow attempt, a format string attack, a denial of service attempt, a web-based attack, and an attempted rights escalation. The determining step can also include monitoring the customer network for the security event and determining at least one of nature of the security event, likelihood that the security event is harmful, and the impact of the security event. The determining step may also include detecting, by the data monitor, the occurrence of the security event.

In another embodiment, the security event includes a potential security event. Further, the first component and/or another component may include the data monitor and/or the client computer.

In one embodiment, the querying step can include querying, by the data monitor, the component. The receiving step can include the data monitor transmitting the received first data to a security analysis module for analysis or the data monitor analyzing the first data. The determining whether to query for additional data can also include analyzing the first data to determine whether to query for additional data. The determining step can also include determining, by the data monitor, whether to query for additional data.

In one embodiment, the analyzing step includes populating a trouble ticket or the data monitor analyzing the security event. The analyzing step can also include reporting a result of the analysis.

In another aspect, a method for analyzing a security event in a distributed fashion includes detecting an occurrence of a security event within a customer network, querying a first component of the customer network for data in response to the detected occurrence of the security event, receiving, by a data monitor located within the customer network, first data from the component in response to the query, and determining, based on the received first data, whether to query for additional data. The method also includes the steps of querying at least one of the first component and another component of the customer network to obtain the additional data in response to the determining step and analyzing, by the data monitor, the security event using at least one of the first data and the additional data.

In yet another aspect, the invention includes an apparatus for analyzing a security event within a customer network. The apparatus includes a data monitor, positioned within the customer network, to collect data from at least one component of the customer network in response to a query, and a security analysis module, in communication with the data monitor, to detect an occurrence of the security event. The security analysis module includes a receiver for receiving data from the data monitor, an analyzer, in communication with the receiver, for analyzing the security event, and a querying module, in communication with the analyzer, for querying the data monitor for data repeatedly until the analyzer can analyze the security event using the data.

In one embodiment, the querying module includes a query processor, an analyst, a message router, and/or a resolver. The component can include a client located within the customer network. The apparatus can also include an analyst to modify settings of the data monitor in response to a security event, a query, and/or the data, monitor communications between the data monitor and the security analysis module, initiate the query of the data monitor, and/or modify the query of the querying module.

In one embodiment, the security analysis module can include an event repository to store information about the security event, a message router to direct and receive queries and/or data, and/or a resolver, in communication with the querying module, to provide a location of the data monitor and/or the component to the querying module.

The resolver may have a characteristic table having an attribute of a component in the customer network. The attribute of the component can include type of service provided to the component, company that the component resides in, network address of the component, geographic data of the component, security domain of the component, and information of a service level agreement associated with the component. The security analysis module can also include an arbitrator that prioritizes the security event in multiple security events and/or the data received from the data monitor.

In one embodiment, the arbitrator further comprises a threat analysis engine, a business asset analysis engine, and/or a service level management engine. The threat analysis engine analyzes the security event based on a parameter of the security event to determine the importance of the security event. The business asset analysis engine determines the impact of the security event if left unresolved. The service level management engine determines steps needed to resolve the security event. In one embodiment, the security analysis module, the receiver, the analyzer, and/or the querying module are located on the customer network.

Additionally, the data monitor can include a security defense appliance monitoring the customer network, a security management appliance, in communication with the security defense appliance, receiving a query from the querying module and directing the query to the security defense appliance, and/or a security analysis appliance analyzing the data.

In yet another aspect, an apparatus for analyzing a security event within a customer network includes a data monitor, positioned within the customer network, to collect data from the customer network, a security analysis module, in communication with the data monitor, to determine an occurrence of the security event, a receiver for receiving data from the data monitor, an analyzer, positioned within the customer network, for analyzing the security event, and a querying module, in communication with the analyzer, for querying the data monitor for data repeatedly until the analyzer can analyze the security event using the data.

In one embodiment, the data monitor includes a security defense appliance monitoring the customer network, a security management appliance, in communication with the security defense appliance, receiving a query from the querying module and directing the query to the security defense appliance, and a security analysis appliance analyzing the data. The analyzer can also include the security analysis appliance. In one embodiment, the security analysis module, receiver, and/or querying module are located within the customer network.

### BRIEF DESCRIPTION OF THE DRAWINGS

The advantages of the technology described above, together with further advantages, may be better understood by referring to the following description taken in conjunction with the accompanying drawings. In the drawings, like reference characters generally refer to the same parts throughout the different views. Also, the drawings are not necessarily to scale, emphasis instead generally being placed upon illustrating the principles of the technology.

FIG. 1 is a block diagram of an embodiment of a security analysis system having a server with a security analysis module and a customer network.

FIG. 2 is a block diagram of another embodiment of a security analysis system having two firewalls within a customer network.

FIG. 3 is a flow chart illustrating an embodiment of the steps performed by the security analysis module.

FIG. 4 is a block diagram of an embodiment of the security analysis module of the server having an arbitrator.

FIG. 5 is a block diagram of an embodiment of the arbitrator having a threat analysis engine executing within the security analysis module.

FIG. 6 is a flow diagram illustrating an embodiment of the steps performed by the threat analysis engine.

FIG. 7A is a block diagram of an embodiment of a data monitor in the customer network.

FIG. 7B is a block diagram of an embodiment of the data flow in the data monitor.

FIG. 8 is a flow chart illustrating an embodiment of the steps performed by the data monitor.

### DETAILED DESCRIPTION

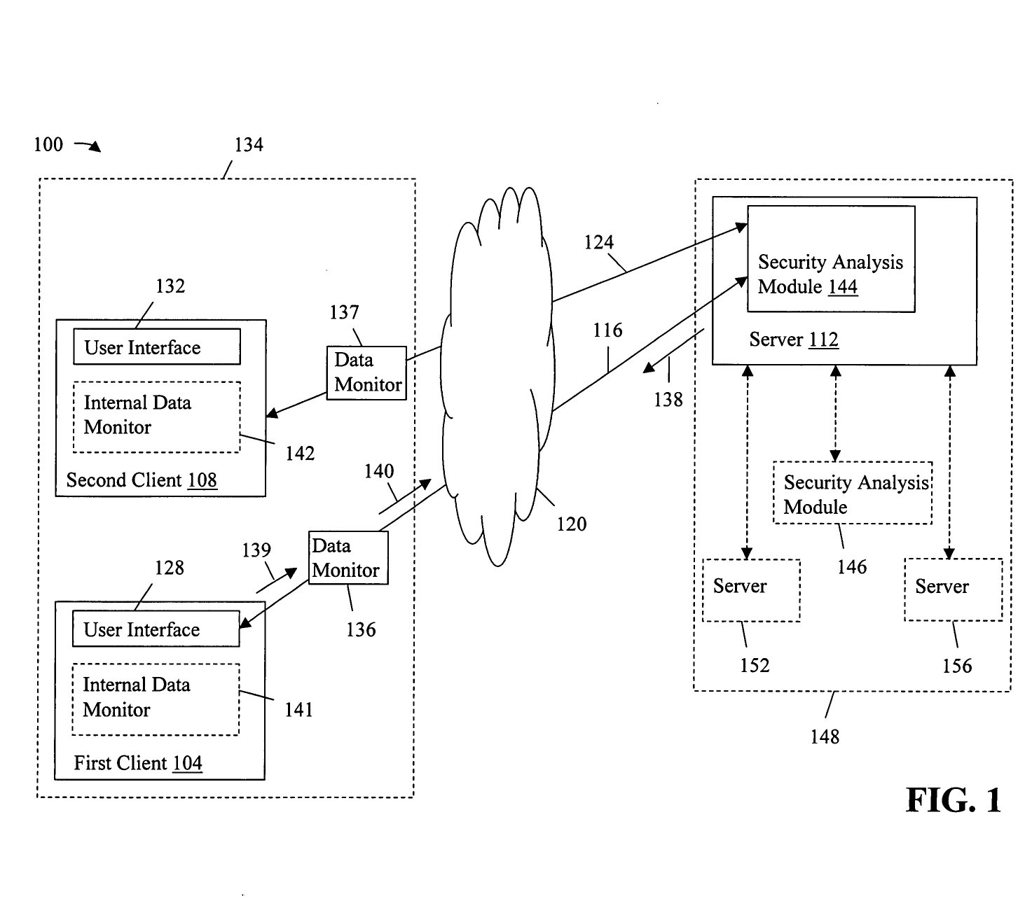

Referring to FIG. 1, a networked security analysis system 100 enables the monitoring and/or analysis of one or more security events. In particular, the security analysis system 100 can monitor and manage one or more firewalls in a customer's network, detect intrusion of a customer network, provide anti-virus protection, provide virtual private network (VPN) services, and/or provide Uniform Resource Locator (URL) filtering. In some embodiments, the security analysis system 100 can also test the vulnerability of a customer's system, facilitate development of infrastructure, provide post-security event forensics, provide recovery services after the occurrence of one or more security event, or any combination of these functions.

An example of a security event that the security analysis system 100 resolves is an indication of a possible attack in progress, such as a port scan of the ports of a device on a customer's network. In particular, an unauthorized user can scan the device's communication ports (i.e., a port scan) to, for instance, attempt to locate a weakened access point for entry into the customer's network. Other examples of security events include service probes, banner checks, signatures from actual attacks in progress, a buffer overflow attempt, a format string attack (e.g., using a low level software function to subvert a system), a denial of service (DOS) attempt (e.g., overflowing the system with requests so that the system has to shut down), a web-based attack (e.g., a CGI attack), and an attempted rights escalation (e.g., connecting to a system as a legitimate user and subsequently changing the privileges of the user (e.g., by changing the effective user ID) so that the user becomes a “more powerful” user, such as a “superuser”).

In one embodiment, the security analysis system 100 includes a first client computer (or first client) 104 and a second client computer (or second client) 108 in communication with a server computer (or server) 112. The first client 104 communicates with the server 112 over a first client-server communications path 116 and a communications network 120. Similarly, the second client 108 communicates with the server 112 over a second client-server communications path 124 and the communications network 120. It should be noted that FIG. 1 is an exemplary embodiment intended only to illustrate, and not limit, the subject technology. Unless otherwise noted, the description that follows is directed toward the first client 104. Nonetheless, the description applies equally to the second client 108 (and any additional client devices). Moreover, although the security analysis system 100 is illustrated in FIG. 1 with two clients 104, 108, the security analysis system 100 supports any number of clients.

In one embodiment, the client 104 can be a personal computer (e.g., 386, 486, Pentium, Pentium II, or Macintosh computer), Windows-based terminal, network computer, wireless device, information appliance, RISC Power PC, X-device, workstation, mini computer, main frame computer, personal digital assistant (PDA), or other computing device that can connect to a network. Moreover, although described above and below as a client computer, the client 104 can be any source or recipient of data. Operating systems supported by the client 104, 108 can include, without limitation, the MICROSOFT WINDOWS family, MAC/OS, and UNIX. The client 104 can include a visual display device (e.g., a computer monitor), a data entry device (e.g., a keyboard), persistent or volatile storage (e.g., computer memory) for storing downloaded application programs, a processor, and a mouse.

Each client 104, 108 may also include a respective user interface 128, 132 (generally user interface 128). The user interface 128 can be text driven (e.g., DOS) or graphically driven (e.g., Windows). In one embodiment, the user interface 128 is a web browser, such as INTERNET EXPLORER developed by Microsoft Corporation (Redmond, Wash.). In a further embodiment, the web browser 128 uses the existing Secure Socket Layer (SSL) support developed by Netscape Corporation (Mountain View, Calif.) to establish the communications network 120 as a secure network.

In one embodiment, the second client-server communications path 124 may have different characteristics (e.g., different transmission data rate) than the first client-server communications path 112. In another embodiment, the second client-server communications path 124 passes through a different network than the communications network 120.

The communications network 120 can be a local-area network (LAN), a medium-area network (MAN), a wide area network (WAN) such as the Internet or the World Wide Web (i.e., web), or a peer-to-peer network. In one embodiment, the communications network 120 supports secure client-server communications. In a further embodiment, communications between the server 112 and the client 104 occur after the server 112 verifies a client user's password. Exemplary embodiments of the communications path 116, 124 include standard telephone lines, LAN or WAN links (e.g., T1, T3, 56 kb, or X.25), broadband connections (ISDN, Frame Relay, ATM), and wireless connections. The connections over the communications path 116, 124 can be established using a variety of communication protocols (e.g., TCP/IP, IPX, SPX, NetBIOS, Ethernet, RS232, and direct asynchronous connections).

In one embodiment, the clients 104, 108 are part of a customer network 134. The customer network 134 can be the portion of the security analysis system 100 at which the security event occurs. Moreover, the customer network 134 is the portion of the security analysis system 100 that the server 112 monitors and analyzes.

The customer network 134 also includes a first data monitor 136 and a second data monitor 137. Although described below in terms of the first data monitor 136, the description can apply to the second data monitor 137 and any additional data monitor in the system 100. The data monitor 136 is in communication with the server 112 over the network 120. In one embodiment, each data monitor 136, 137 is associated with or resides in a particular client 104.

The data monitor 136 receives a query (or question) 138 from the server 112 for information. The query 138 can be in response to a security event. The query 138 may be, for instance, an email message, an audio message, a pictoral message, the setting of one or more software flags, the setting of one or more bits, or any other technique used to request data from the data monitor 136.

Once the data monitor 136 receives the query 138, the data monitor 136 collects client data 139 from the client 104. Each data monitor 136 can then gather client data 139. The data monitor 136 can then analyze and/or store the client data 139. In one embodiment, the data monitor 136, 137 also transmits all of or a portion of the client data 139 to the server 112 as a query response 140.

In one embodiment, the data monitor 136 is a software module running on a computer or other device. The data monitor 136 may alternatively (or additionally) include a database or memory element, such as random access memory (RAM) or read-only memory (ROM). Although illustrated as external data monitors 136, 137, one or both data monitors 136, 137 can be internal data monitors 141, 142 executing within the first client 104 and/or the second client 108.

The data monitor 136 can collect client data 139 having any form. Moreover, the client data 139 may relate to security events, customer network vulnerabilities, and/or customer network traffic. In one embodiment, the security analysis module 144 performs one or more defensive actions in response to a particular security event and/or in response to the analysis of the particular security event.

Similar to the client 104, the server 112 can be any computing device (e.g., personal computer) described above. Preferably, the server 112 will be configured with sufficient processing power, memory, and storage to operate as a server-class computer. The server 112 hosts one or more applications that the client 104 can access over the communications network 120. The application can be, for example, a graphical user interface, tabular illustration, plot, spreadsheet program, word processing program, etc.

In one embodiment, the server 112 is a service provider (e.g., an application service provider, or ASP) providing security services to the client 104. In one embodiment, the server 112 is a managed security service provider (MSSP). In further embodiments, an administrator of the server 112 and an administrator of the client 104 agree to a service-level agreement (SLA). In particular, the SLA is an agreement that commits the ASP to a required level of service. The SLA can contain a specified level of service, support options, enforcement or penalty provisions for services not provided, a guaranteed level of system performance as relates to downtime or uptime, a specified level of customer support, and what software or hardware is provided and the required fee. Each administrator may be a person, an organization such as a corporation, or a computing device having a particular set of criteria that must be met by the other party before the computer can accept an SLA.

The server 112 additionally includes a security analysis module 144. The security analysis module 144 analyzes one or more security events that occur within the security analysis system 100. In one embodiment, the security analysis module 144 receives one or more query responses 140 from the data monitor 136 and analyzes the data (i.e., the query response(s) 140) for security threats. In a further embodiment, the security analysis module 144 prioritizes the security events based on their importance to the security of the customer network 134.

The security analysis system 100 enables analysis of data (e.g., the query response 140) in a distributed fashion instead of using a centralized data model. In one embodiment, the analysis of data in a distributed fashion corresponds to one or more devices within the customer network 134 and/or server 112 that are each dedicated to a particular task. Additionally, although illustrated in FIG. 1 as a module located within the server 112, the security analysis system 100 may instead or additionally include an external security analysis module 146 in communication with the server 112 and/or the customer network 134.

In another embodiment, the server 112 is a member of a server farm 148, which is a logical group of one or more servers that are administered as a single entity. In the embodiment shown, the server farm 148 includes the server 112, a second server 152, and a third server 156, each of which may include a security analysis module 144.

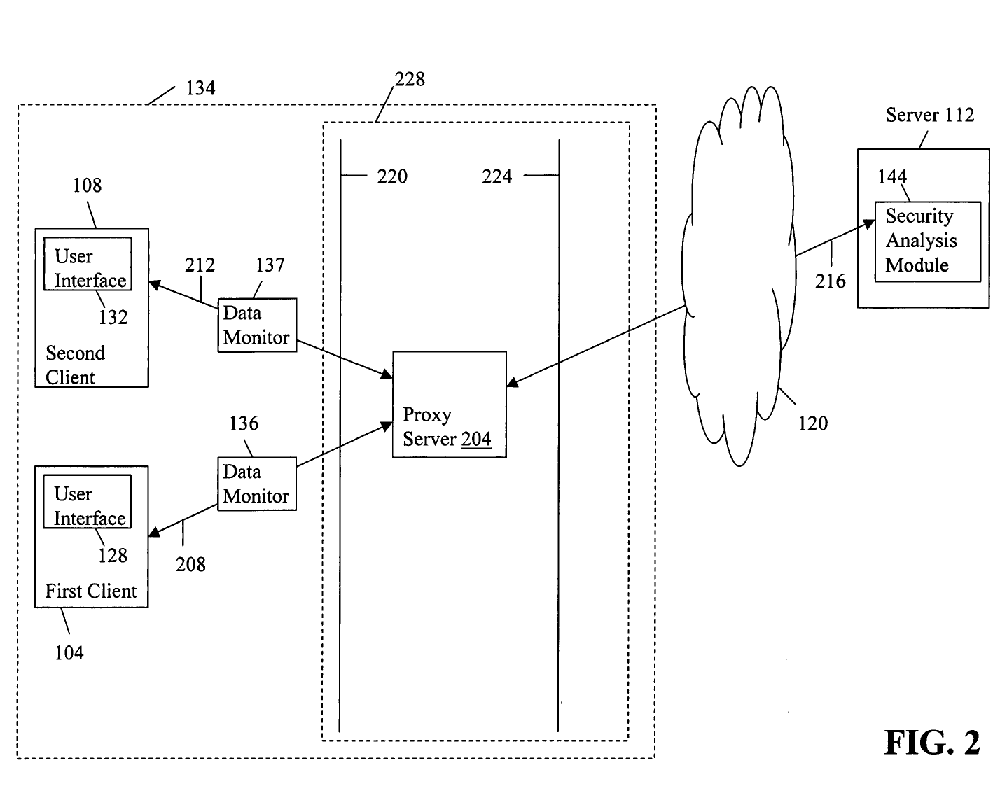

With reference to FIG. 2, a proxy server 204 may be employed to increase the security of the customer network 134. The proxy server 204 is in communication with the first client 104 over a first proxy-client communications path 208 and in communication with the second client 108 over a second proxy-client communications path 212. The proxy server 204 communicates over the communications network 120 using a proxy-server communications path 216. The proxy server 204 can be any sort of computing device, as described above.

In one embodiment, the customer network 134 also includes a client firewall 220 separating the proxy server 204 and the clients 104, 108 and a network firewall 224 separating the proxy server 204 from the communications network 120. The firewalls 220, 224 prohibit unauthorized communications (e.g., messages) to/from the customer network 134. Each firewall 220, 224 can be a router, computer, or any other network access control device. The customer network 134 can alternatively include one of the firewalls 220, 224 or no firewall. The network between the firewalls 220, 224 is often referred to as a “demilitarized zone,” (DMZ) 228.

The proxy server 204 serves as a security gateway through which communications to either client 104, 108 from the network 120 must pass. In one embodiment, the network firewall 224 rejects any incoming communication from the proxy-server communications path 216 that does not have the proxy 204 as its destination. Likewise, the network firewall 224 repudiates any outgoing communication for the proxy-server communications path 216 unless its source is the proxy 204. Although illustrated as a proxy 204, the security gateway can alternatively be, for example, a router, firewall, or relay.

In one embodiment, the security analysis system 100 automatically manages the firewalls 220, 224. In another embodiment, the security analysis system 100 enables manual management of the firewalls 220, 224, such as by accepting input from an operator or administrator.

Moreover, in one embodiment, the data monitors 136, 137 are located behind the client firewall 220 and outside of the DMZ 228 to monitor the clients 104, 108 and/or the client firewall 224. In another embodiment, the data monitors 136, 137 are located within the DMZ 228, such as between the two firewalls 220, 224. This may occur during the monitoring of the proxy server 204, the network firewall 224, and/or the client firewall 224. Although described above and below as client data 139, the data monitor 136 can instead or additionally transmit data regarding one or both firewalls 220, 224, the DMZ 228, and/or the proxy server 204.

Even with an occurrence of one security event, a wide range of data can facilitate the security analysis module's proper determination and resolution of the security event. To accurately determine what the security event is and to resolve the event, the security analysis module 144 determines whether the event occurred (or if the so-called event is a mere glitch or noise). If the event occurred, the security analysis module 144 can determine the nature of the event (e.g., from a natural occurrence, such as from malfunctioning software, or malicious software). Moreover, in another embodiment, if the security analysis module 144 determines that the event is malicious, the security analysis module 144 determines the hosts/services targeted by the attacking party and/or the magnitude of the attack. The security analysis module 144 may also be able to determine how to prevent the attacker from reaching their goals, predict what the next sequence of events will be, and/or who future affected parties may be. In yet further embodiments, the security analysis module 144 assigns a probability of occurrence to future predictions. In one embodiment, the security analysis module 144 includes an analyzer module to analyze the security event.

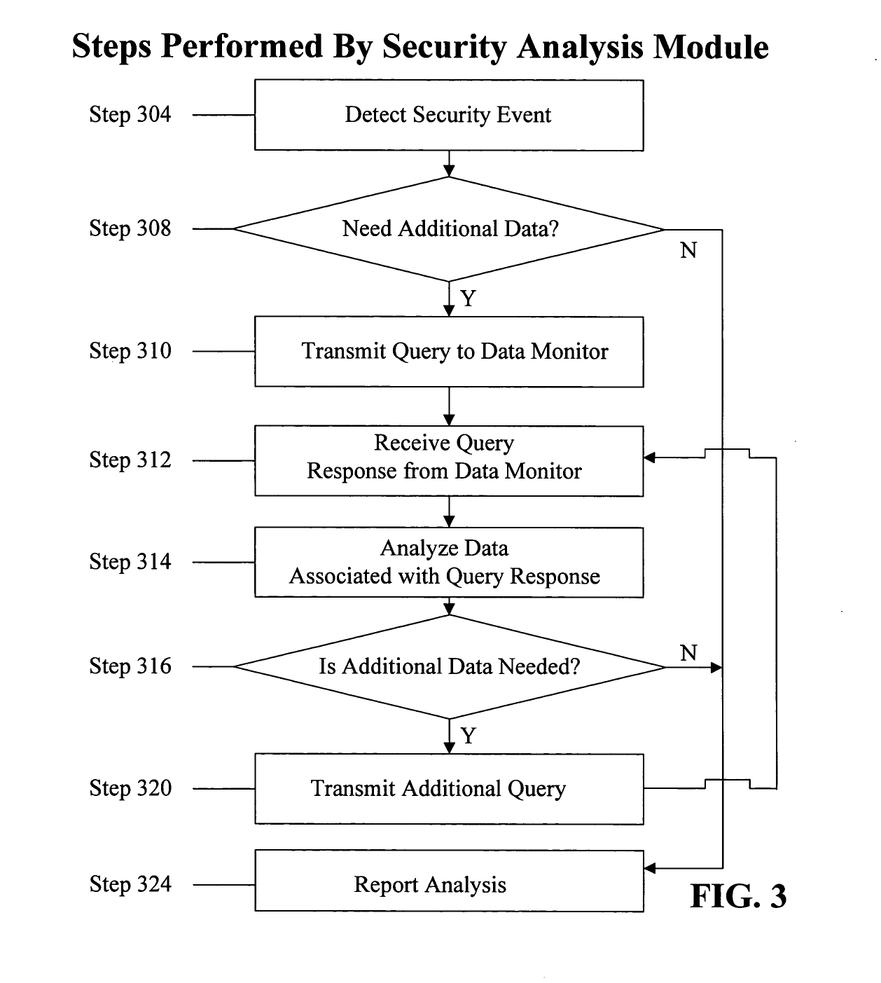

Referring to FIG. 3, the security analysis module 144 initially detects a security event (step 304). The security event may occur in any module described above and below, such as the client 104, the data monitor 136, or any module executing within the customer network 134. The security analysis module 144 then determines if analysis of the detected security event requires data (e.g., client data 139) from one or more components (e.g., of the customer network 134, such as the data monitor 136) (step 308).

In one embodiment, the security analysis module 144 determines in step 308 that it does need data from the data monitor 136. If the security analysis module 144 needs data from a component of the customer network 134, the security analysis module 144 transmits a query 138 to the data monitor 136 requesting data from a particular device (e.g., client 104) in the customer network 134 (step 310).

The data monitor 136 receives the query 138 and obtains the client data 139 (or data from any other device, such as data from the client or network firewall 220, 224). As described above, the data monitor 136 then transmits a query response 140 to the server 112. In one embodiment, the data monitor 136 packages the client data 139 into a message object and transmits the message object to the server 112. The server 112 subsequently receives the query response 140 (or message object) (step 312) and analyzes the data associated with the query response 140 (step 314).

In one embodiment, the security analysis module 144 populates a trouble ticket during its analysis of the query response 140. The security analysis module 144 can also generate response entries in a queue (as described in more detail below) during its analysis. The security analysis module 144 may also log the receiving of the query response 140. Moreover, the security analysis module 144 may perform anomaly detection (e.g., a system starts acting in a manner different than it usually does (e.g., load difference, accessing different ports, etc.)), determine if a customer's network 134 is being watched, predictive analysis (e.g., how likely or easy can an attacker attack the customer's network 134), etc.

The security analysis module 144 then determines whether additional data is needed for its analysis of the security event (step 316) as part of its analysis. If the security analysis module 144 determines that it needs additional data, the security analysis module 144 transmits one or more additional queries 138 to the customer network 134 (step 320). The security analysis module 144 then repeats steps 312-320 until determining that additional queries are not needed (step 316).

When the security analysis module 144 determines that its analyses of the security event can complete without receiving additional data from the customer network 134, the security analysis module 144 reports the results of its analysis of the data (step 324). This determination may occur either initially after step 304 (i.e., a no-op occurs) or after receiving one or more additional query responses 140 after transmitting additional queries 138 in step 320. Further, this determination may occur after several iterations of steps 312-320.

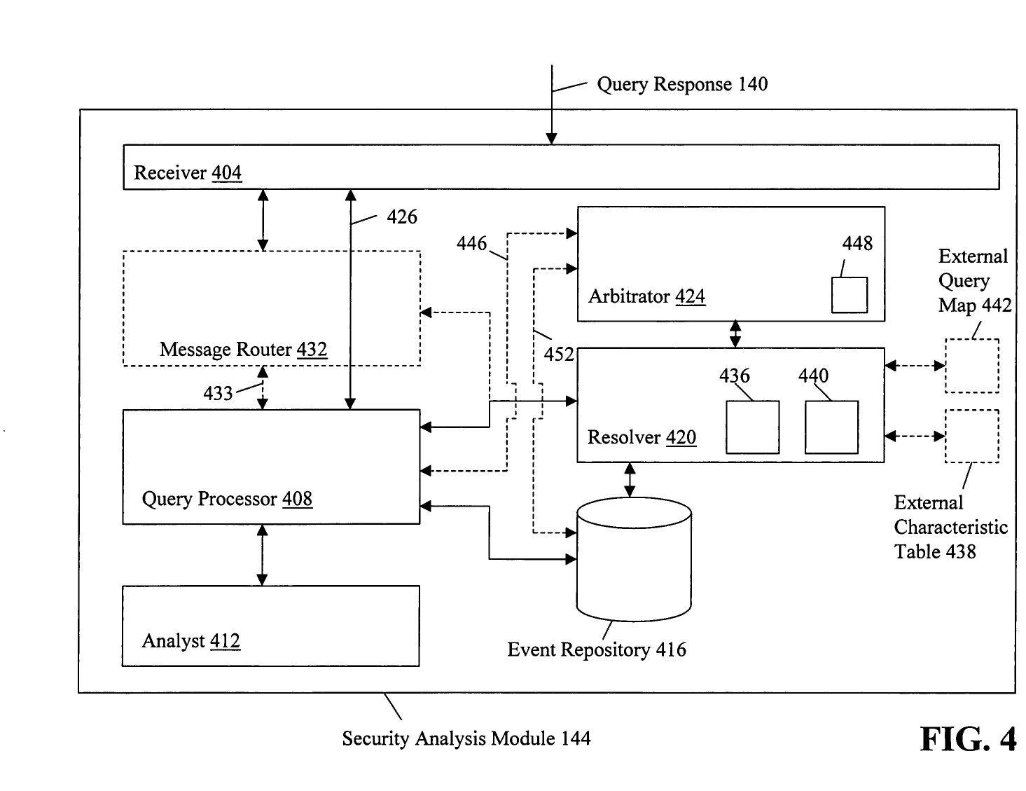

Referring to FIG. 4, the security analysis module 144 includes a receiver 404, a query processor 408, an analyst 412, an event repository 416, a resolver 420, and an arbitrator 424. In one embodiment, these components 304-324 are software modules (e.g., software components) executing within the security analysis module 144. In another embodiment, one or more of these modules 404-424 are externally located from the security analysis module 144 and communicate with the security analysis module 144. In yet another embodiment, one or more of these modules 404-424 are externally located from the server 112 and communicate with the server 112.

In one embodiment, the receiver 404 is a software module that receives the query response 140 from the data monitor 136. In one embodiment, the receiver 404 executes within the server 112. In other embodiments, the receiver 404 is a software module executing as part of another module of the server 112 (e.g., the query processor 408). In further embodiments, the receiver 404 is a transceiver and transmits queries 138 as well as receives query responses 136 from the data monitor 136.

The receiver 404 is in communication with the query processor 408 and transmits the data associated with the query response 140 to the query processor 408 over the processor-receiver communication path 426. In one embodiment, the query processor 408 provides transactional processing support (i.e., ensuring that all necessary steps to perform analysis are completed and that partial analysis does not skew results). Moreover, in one embodiment the query processor 408 is in communication with the analyst 412. Examples of the query processor 408 include a Customer Relationship Management (CRM) system, an Intrusion Detection System (IDS), a Help Desk system, and a Voice Response System.

An example of the query processor 408 is HPOpenView, developed by Hewlett Packard of Palo Alto, Calif. In another embodiment, the query processor 408 is a hand-held system (e.g., a PDA, a cellular phone, or a pager) where an analyst 412 receives a notification in response to a security event. The notification can be, for instance, an alarm on the PDA, a phone call on the cellular phone, or a page via the pager.

In one embodiment, the security analysis module 144 uses the query processor 408 as an interface to present information about the security events to the analyst 412. In one embodiment, the query processor 408 displays a root cause analysis to the analyst 412. Additional examples of analyses performed and/or displayed by the query processor 408 include a response analysis and/or a certainty analysis of events that may have recently occurred or are likely to occur in the future.

The analyst 412 can be an operator or administrator of a component of the customer network 134 or an operator or administrator of a component of the server 112. In another embodiment, the analyst 412 is an internal module of the server 112 (e.g., executing within the security analysis module 144) or a module in communication with the server 112. The analyst 412 can also operate in one or more modes, such as a passive mode or an active mode. When operating in the passive mode, the analyst 412 watches communications (e.g., queries or query responses) to and from the customer network 134. When operating in the active mode, the analyst 412 can actively modify one or more components of the customer network 134 (or the server 112) in response to a security event, query 138, or a query response 140. This active modification includes, for example, the shutting down of one or more components of the customer network 134 (or server 112). In yet another embodiment, the analyst 412 initiates a query 138. For example, if the analyst 412 determines erratic or unusual behavior relative to the normal behavior of a component in the customer network 134, the analyst 412 can initiate a query 138 of the component to determine the cause of the behavior. For example, the analyst 412 can initiate a query 138 in response to an external event, such as a political change or a threat of war.

In one embodiment, the query processor 408 also communicates with the event repository 416. The event repository 416 may be a database or directory that stores information about events.

In another embodiment, the query processor 408 is in communication with a message router 432 over a query-router communication path 433. In one embodiment, the message router 432 is a software module that receives and transmits the queries and query responses as messages. In one embodiment, the message router 432 uses Java Messaging Service (JMS) technology, developed by Sun Microsystems of Santa Clara, Calif. This can enable the delivery of data via a data object wrapped in a message object. In one embodiment, the message router 432 delivers objects to destinations based on message object type matching message handler type. Moreover, the message router 432 may enable local caching and subsequent guaranteed message delivery.

In one embodiment, the resolver 420 is in communication with the query processor 408 and provides a location service to the query processor 408. In particular, the resolver 420 determines the location of a nearby client 104 that may be able to answer a particular question of interest (e.g., from the query processor 408). In an additional embodiment, the resolver 420 includes a characteristic table 436. The characteristic table 436 includes characteristics and attributes of one or more clients 104. The characteristic table 436 may be, for example, searchable by characteristic or attribute, by client 104, or by a data monitor 136 (e.g., a data monitor 136 having client data 139 associated with a particular client 104). Examples of characteristics include, for instance, types of services provided to the client 104 and company/security domain that the client 104 resides in. The types of services that the server 112 provides to the client 104 can be, for example, resolution services and/or anti-virus services. In an additional embodiment, the table 436 includes the range of network addresses that the resolver 420 has information for. This information may include, for example, Internet Protocol (IP) addresses, geographic data, security domains, service level related (e.g., time periods during which queries 138 may never be asked of clients 104 in a particular company), etc. In one embodiment, these addresses are addresses listed on the network firewall 224.

In a further embodiment, the resolver 420 also includes a query map 440. The resolver 420 uses the query map 440 to determine which clients 104 to query. The map 440 may be organized in a variety of ways, such as by topology (e.g., client 104 located downstream or upstream with respect to the server 104), owner (e.g., security domain), and class of service (e.g., optimum security level package for the client 104, highest need for customer attention (e.g., based on time, value of contract, or monetary amount), highest risk, or most favorable geographic position). Although the table 436 and map 440 are shown as internal components of the resolver 420, the resolver 420 may instead communicate with an external characteristic table 438 and/or an external query map 442. In another embodiment, the external table 438 and/or map 440 may be part of an external database or part of the event repository 416.

Besides the query processor 408, the resolver 420 is also in communication with the event repository 416. The resolver 420 accesses the event repository 416 when the resolver 420 stores data after the server 112 receives a query response 140. In one embodiment, the resolver 420 employs just-in-time querying by generating and/or requesting data only as necessary. The just-in-time querying enables the resolver 420 to obtain data only when needed. Thus, the just-in-time querying prevents an attacker of the customer network 134 from seeing the data monitor 136 (and/or the server 112) move the client data 139 and/or the query response 140 around in response to a query 138. By reducing the chances of an attacker watching the moving of data, the resolver 420 minimizes the possibility of the attacker circumventing the security measures by altering the attacker's behavior from monitored bands of activity to unmonitored bands of activity. In one embodiment, the just-in-time querying also prevents the resolver 420 from accessing stale data, as the customer network 134 transmits data to the server 112 upon request. Moreover, although illustrated with one resolver 420, the security analysis module 144 may include any number of resolvers 420.

In one embodiment, the resolver 420 communicates with the arbitrator 424. The arbitrator 424 is a software module that prioritizes security events and/or query responses 140 to queries 138. The arbitrator 424 structures the first query 138 in the chain of transactional queries 138. Upon the structuring of the first query 138, the arbitrator 424 may transmit the first query 138 to the query processor 408 (e.g., over an arbitrator-query processor communications path 446) for subsequent delivery to the data monitor 136. In some embodiments, the analyst 412 can review the proposed query 138 that the arbitrator 424 generates and transmits to the query processor 408. Upon such a review, the analyst 412 may determine to change the query 138 or determine not to transmit the query 412 to the customer network 134.

The server 112 (e.g., the query processor 408 or message router 432) then transmits the query 138 to the data monitor 136 for subsequent transmission to the client 104 of interest. The server 112 then receives a query response 140 to the query 138. In one embodiment, the arbitrator 424 subsequently collects the query responses 140 from the resolver 420 and calculates a weight for the query response 140.

The arbitrator 424 can also include a memory element 448. The memory element 448 stores information for the arbitrator's analysis. The memory element 448 can be any type of memory, such as RAM or ROM. Although illustrated as located within the arbitrator 424, the arbitrator memory element 448 may instead be external to and in communication with the arbitrator 424. In yet other embodiments, the arbitrator 424 communicates with the event repository 416, as shown with arbitrator-repository communications path 352, to retrieve and/or store information associated with a security event. In further embodiments, the arbitrator 424 accesses the event repository as a consequence of its communication with the resolver 420. For example, the arbitrator 424 communicates a request for particular information to the resolver 420, and the resolver 420 retrieves this information from the event repository 416 before communicating the information to the arbitrator 424. In some embodiments, the analyzer includes one or more of the modules described above (e.g., the arbitrator 424) or below (e.g. the threat analysis engine 504).

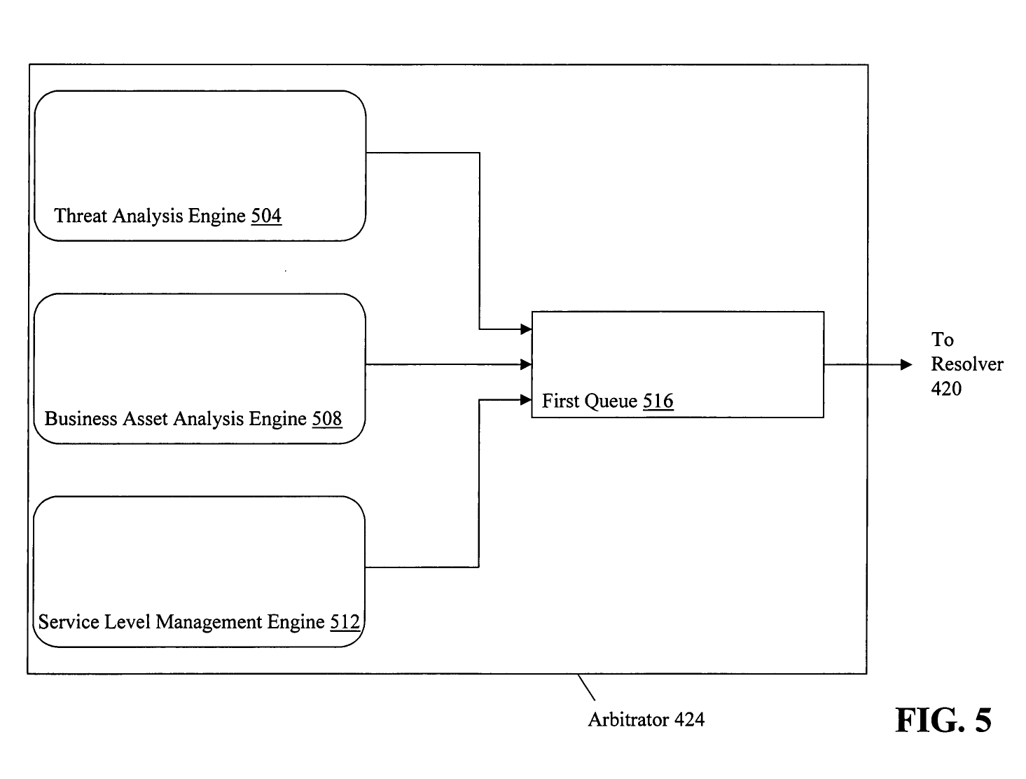

Also referring to FIG. 5, the arbitrator 424 qualifies a security event. To do this, the arbitrator 424 includes a threat analysis engine 504, a business asset analysis engine 508, and a service level management asset engine 412. In one embodiment, each engine 504, 508, 512 is in communication with a queue 516 to prioritize security events. The engines 504, 508, 512 operate according to one or more rules to manage and prioritize security events and/or query responses 140.

The threat analysis engine 504 can base its analysis of a security event on one or more parameters. Examples of the parameters that the threat analysis engine 504 can use to determine importance include, but are not limited to, the amount of time elapsed since the occurrence of the security event, the duration of time of the security event, the number of previous occurrences of the security event, header information of the query response 140, communication protocol, and the type of security event (e.g., denial of service, bus snooping, etc.).

In one embodiment the threat analysis engine 504 determines the importance of a security event based on one or more of these parameters. The correlation between the importance of a security event and the security event can occur in a variety of ways, such as with the placement of the security event in the queue 516, a rating associated with the security event (e.g. importance rating: 90 out of 100) or a software flag associated with the security event (e.g., Extreme, Very High, High, High-Medium, Medium, Medium-Low, Low, Very Low, and Lowest Importance). In another embodiment, the threat analysis engine 504 correlates the importance of a security event and the security event with the type of message that the threat analysis engine 504 communicates. For example, the threat analysis engine 504 may communicate an email if the resolution of a security event has low importance, an email and sound if the security event has medium importance, a voice notification if the security event has high importance, and repeated reminders and voice notifications if the security event has highest importance. The importance of a security event may be useful to the analyst 412 and/or to an operator of the client 104 to determine the speed at which to resolve or address the security event. Thus, if the security analysis module 144 determines that someone has breached a client's security barrier(s) and is performing reconnaissance activities around the client 104, the threat analysis engine 504 recognizes this activity as a security event of high importance. The threat analysis engine 504 may associate an Extreme software flag with this type of security event.

In further embodiments, the threat analysis engine 504 determines the importance of the security event by a portion of the total list of parameters. For example, if the threat analysis engine 504 does not determine an accurate match for the type of security event but does determine the time period(s) associated with the security event (e.g., duration and time elapsed) and its point of origin, the threat analysis engine 504 may determine the importance level from these parameters. Thus, the threat analysis engine 504 extrapolates the importance of a security event based on a portion of the parameters available for such a determination.

The threat analysis engine 504 can correlate a security event with an importance level using one of the techniques described above, such as by assigning a rating or a software flag. Based on this determination, the threat analysis engine 504 adjusts the position of the security event (and/or query response 140) in the queue 516.

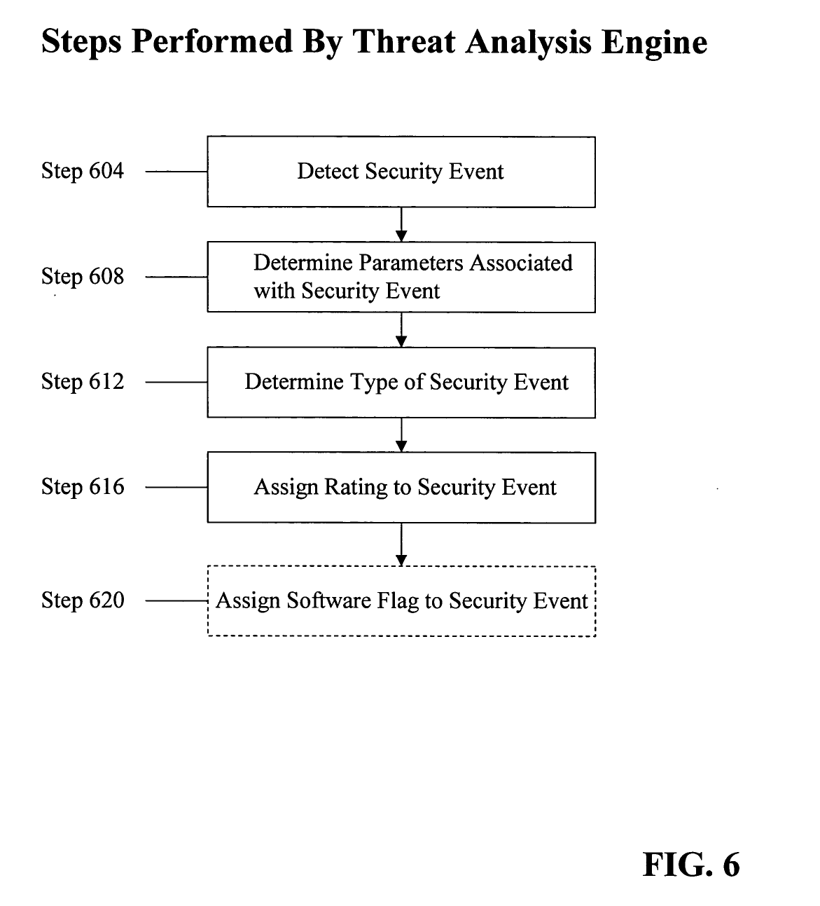

Referring to FIG. 6, the threat analysis engine 504 uses more than one technique to associate an importance level with a security event. For example, the security analysis module 144 detects a security event (step 604). The server 112 queries one or more clients 104 based on the security event. After the arbitrator 424 receives the query responses 140, the threat analysis engine 504 determines the value of one or more parameters associated with the security event (step 608). In one embodiment, the threat analysis engine 504 determines a first tier of parameters, such as parameters that deal with time of the security event (e.g., duration and time elapsed). The threat analysis engine 504 may use the first tier parameters to facilitate the determination of a second tier of one or more parameters, such as the type of security event occurring (step 612). Thus, the threat analysis engine 504 can classify the parameters into a multi-tiered (e.g., five-tiered) arrangement, using some or all parameters from a lower tier to facilitate the determination of one or more parameters at a higher tier.

The threat analysis engine 504 can alternatively select a type of security event from a list of security events stored in the arbitrator memory element 448 and/or the event repository 416 (step 612). The threat analysis engine 504 can select the type of security event that most closely matches the security event at issue by, for instance, comparing parameters associated with the security event at issue with stored parameters associated with previous security events. If the security event at issue does not correspond to a stored security event, the threat analysis engine 504 may store information about the security event at issue for reference upon future occurrences of the security event. The threat analysis engine 504 may additionally direct the server 112 to transmit one or more additional queries 138 to the data monitor 136 to obtain more information associated with the security event or information that may facilitate the determination of the security event.

Once the parameters are determined, the threat analysis engine 504 then assigns a rating to the security event (step 616). Based on this rating, the threat analysis engine 504 may also assign a software flag to the security event corresponding to the rating (step 620), such as assigning an Extreme flag for a security event having a rating of 95 or greater. Although illustrated in a particular order, the threat analysis engine 504 can perform steps 504-520 in any order.

The business asset analysis engine 508 determines the impact of the security event to the security analysis system 100 as a whole. For example, the business asset analysis engine 508 may provide information relating to the business risk associated with not resolving a security event. This business risk may be evaluated and reported in cost, time, effect to customer network 135, and/or effect to components (e.g., client 104) of the customer network 135. In another embodiment, the business asset analysis engine 508 provides information such as maximum down-time that one or more components of the customer network 134 can experience in response to a security event, costs associated with the down-time, estimated man-hours to resolve the security event and/or the problems caused by the security event, etc. Thus, the business asset analysis engine 508 utilizes anecdotal and/or abstract information received from the data monitor 136 to produce information relevant to a business. For example, the business asset analysis engine 508 can provide an industry trend analysis service for the customer.

The service level management engine 512 determines the steps that need to occur to resolve the security event. The service level management engine 512 also can determine the time period at which a security event needs to be resolved (i.e., a resolution time). The service level management engine 512 can also review the time stamp of the security event before recommending a resolution time. In one embodiment, the service level management engine 512 corresponds the resolution time to the importance of a security event. For instance, the service level management engine 512 designates a resolution time of 1 minute for a security event that achieves an Extreme level of importance.

In other embodiments, the service level management engine 512 bases the determination of the resolution time on an agreement, such as a service level agreement (SLA) as described above. Therefore, the service level management engine 512 can ignore the importance level of an event if the SLA designates a different (e.g., faster) resolution time for a particular security event.

The queue 516 is a first-in-first-out (FIFO) queue with prioritization such that the initial position in the queue is determined by priority. The nature of the queue 516 causes the arbitrator 424 to reposition security events having a higher level of importance at the front of the queue 516 so that these events are reported and/or resolved before less important security events. The queue 516 may instead be a last-in-first-out (LIFO) queue that has prioritization, consequently causing the arbitrator 424 to reposition the security events in the opposite manner (i.e., the security events closest to the back part of the queue are dealt with first). In another embodiment, the arbitrator 424 includes multiple queues, such as one queue for each priority or for each engine 504, 508, 512.

Each module (e.g., data monitor 136, query processor 408, message router 432, each engine 504, 508, 512, and the queue 516) can be written in a specific programming language (e.g. C++, Java, C#, Fortran, Perl, etc.), or may be coded in one of a choice of programming languages or coding formats. Moreover, each module can be an entire computer application program or a large or small portion of a computer application program (e.g. a subroutine or a subsystem, one or more objects, etc.).

The security analysis module 144 notifies the customer and/or administrator of the server 112 about the results generated by one or more of the engines 504, 508, 512. The notification may be in any form, such as in a graphical form, a tabular form, a textual form (e.g., an email), an audio form (e.g., having a voice recognition speech synthesis software module “reading” the information), a pictorial form, and the like. Further, any module described above can perform this notification function. For example, the analyst 412 can report a result of a security test of the customer network 134, such as with a level of accuracy in an accuracy scale (e.g., two out often possible points). The analyst 412 can provide a web portal for reporting information to, for example, an administrator of the customer network 134. Alternatively, a reporting module (internal or external to the server 112) communicates with the server 112 and the data monitor 136 to obtain the information to report.

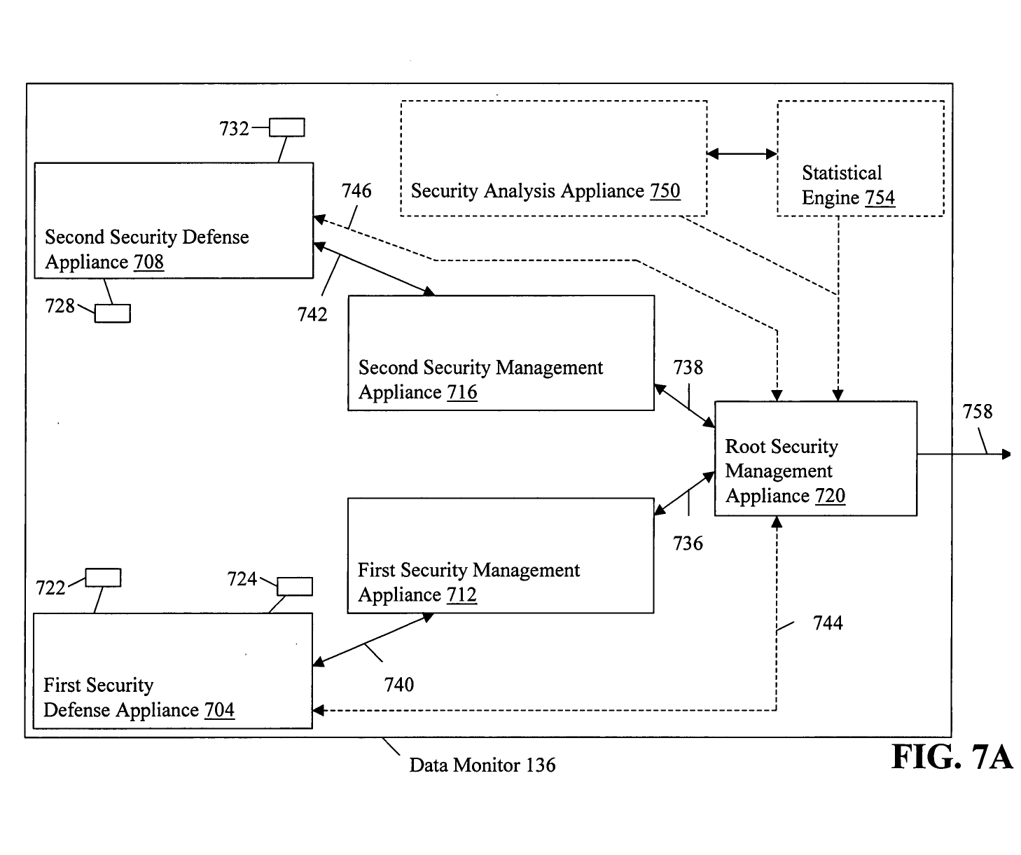

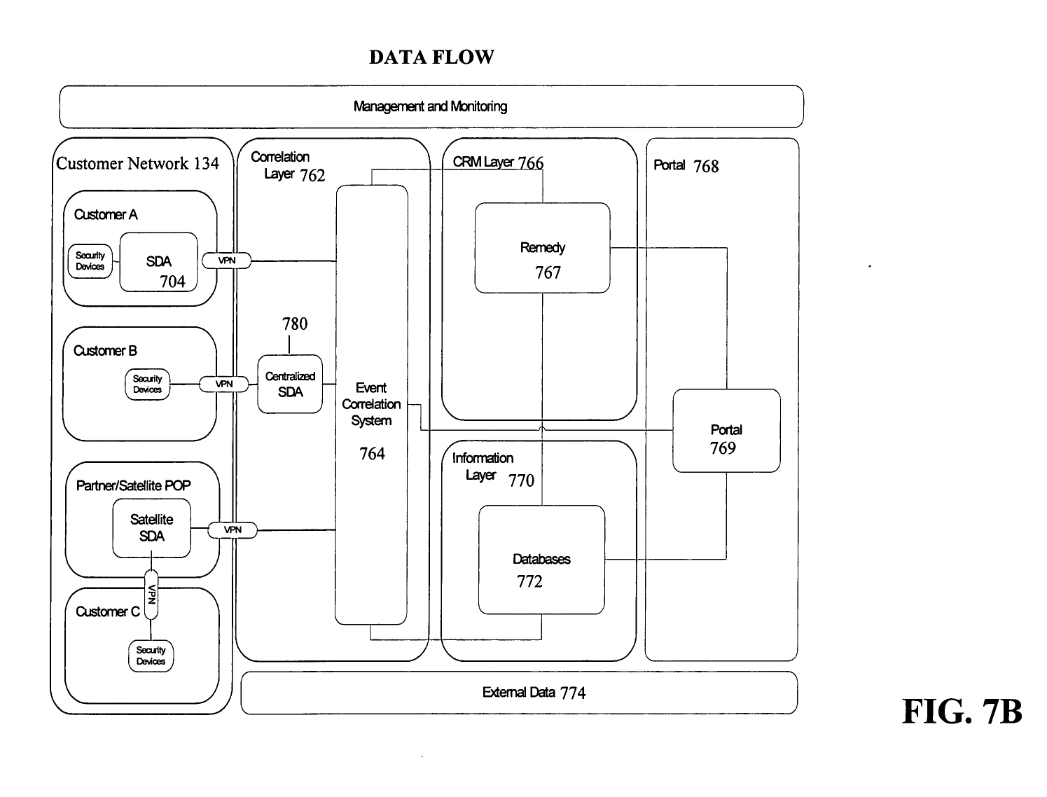

Referring to FIG. 7A, to manage the large amounts of client data 139 needed to analyze a security event, the security analysis system 100 distributes the processing and the storage of the client data 139 with the data monitor 136 located within the customer network 134. In one embodiment, the data monitor 136 includes, for example, a first and second security defense appliance (SDA) 704, 708, a first and second security management appliance (SMA) 712, 716, and a root SMA 720. Although the description below is focused on the first SDA 704 and the first SMA 712, the respective description may apply equally to the second SDA 704 and/or the second SMA 712. Moreover, the security analysis system 100 may include any number of additional data monitors having any number of these components (e.g., SMA or SDA).

Any or all of the components of the data monitor 136 serve as a data aggregation platform that can provide intelligent abstraction of disparate data sources (e.g., the client 104) and normalize the client data 139 into a local memory element, such as a local cache. The memory element may be a memory element local to the data monitor 136, a component of the data monitor 136 (e.g., SDA 704), or even the client 104.

The security analysis system 100 uses the SDA 704 to monitor the customer network 134. In one embodiment, the client 104 generates one or more logs during operation, such as an access log listing requests to the client 104 for files. The SDA 704 can then gather these logs from each client 104. After obtaining the logs, the SDA 704 can analyze the logs for particular data and/or transmit the logs or a portion of the logs to the server 112 for analysis. Moreover, the SDA 704 may perform this analysis and/or transmission of the logs to the server 104 in response to a query 138.

Additionally, the SDA 704 can enable the remote testing of the DMZ 228 and/or the customer network 134 as a whole. The SDA 704 may also enable remote testing of the customer network 134 or a portion of the customer network 134. The SDA 704 may additionally detect and categorize “hidden” vulnerabilities of the customer network 134, such as a vulnerable ftp server which is filtered by a firewall but accessible from an alternative path, such as another compromised host used as an attack staging ground (i.e., a “launchpad”).

Additionally, the first SDA 704 can include a first group of sensors (e.g., a first and second sensor 722, 724) and the second SDA 708 can include a second group of sensors (e.g., a first and second sensor 728, 732). Although each SDA 704, 708 is shown with a respective group of sensors, each SDA 704, 708 may have any number of sensors (e.g., the first SDA 704 may have four sensors and the second SDA 708 may not have any sensors). In one embodiment, each sensor 722, 724, 728, 732 can perform session sniping, which is terminating the session. One or more of the sensors 722, 724, 728, 732 may also block communication ports. The SDA 704, 708 collects information from its respective sensors 722, 724, 728, 732 as part of the client data 139.

The root SMA 720 is a component that receives the queries 138 from the server 112. The root SMA 720 then directs the query 138 to the appropriate SDA 704, 708 and/or SMA 712, 716. In one embodiment, the root SMA 720 communicates with each SMA 712, 716 over a respective root SMA-SMA communications path 736, 738. Moreover, each SMA 712, 716 may communicate with SDA 704, 708 over a respective SMA-SDA communications path 740, 742. The root SMA 720 may instead directly communicate with the SDA 704, 708 via a respective root SMA-SDA communications path 744, 746.

In another embodiment, the server 112 transmits a query 138 directed to a sensor 722, 724, 728, 732. In particular, the resolver 420 locates, for instance, the first sensor 722 for a particular query 138 and the server 112 subsequently transmits the query 138 to the root SMA 720 for transfer to the SDA 704. The SDA 704 then transmits the query 138 to the sensor 722 of interest. In other embodiments, the root SMA 720 transmits the query 138 directly to the sensor 722.

Thus, the SDA 704, 708 and/or the SMA 712, 716 transmit all client data 139 to the root SMA 720 for subsequent transfer to the server 112. The root SMA 720 can be any type of routing device. Moreover, although shown with one root SMA 720, the data monitor 136 may include any number of root SMAs 520 (e.g., zero, one, or five). Further, in one embodiment, the SMA 712 is a device that is located closer to the perimeter of the customer network 134 relative to the SDA 704. Additionally, in one embodiment, any device executing within the data monitor 136 may communicate with any other device in the data monitor 138.

The data monitor 136 may also include a security analysis appliance (SAA) 750. The SAA 750 is a component that aggregates a subset of client data 139 and searches through the data 139 for patterns. The SAA 750 can search for particular patterns in the data 139. For example, the SAA 750 can be a statistical engine 754 that gathers all statistical data 139 from the clients 104. Instead of transmitting raw query response data 140 to the server 112, the statistical engine 754 can transmit statistical data 140 to the server 112. Examples of the statistical data 140 that the statistical engine 754 can transmit to the server 112 includes statistics such as that 10,000 security events have occurred, 20% were originated at a certain IP address, 8% occurred in the last three minutes, etc. The SAA 750 may additionally communicate with an external statistical engine. The external statistical engine can be, for instance, an application server that executes as a front-end to the data monitor 136. Further, the SAA 750 can operate as the back-end so that the SAA 750 can calculate the query response 140 by using a substantial amount of client data 139 without having to transmit the data 139 outside of the customer network 134. Moreover, the SAA 750 and/or the statistical engine 754 may transmit results to the root SMA 720 for subsequent transmission to the server 112.

In one embodiment, the root SMA 720 communicates with the server 112 via a data monitor-server communications path 758. Further, the data monitor-server communications path 758 may be encrypted to ensure secure and reliable communications between the server 112 and the data monitor 136 (e.g., root SMA 720). For example, the data monitor 136 and the server 112 may communicate using public-key encryption (e.g., MD5). In some embodiments, the data monitor-server communications path 112 is a Data Encryption Standard (DES) encrypted tunnel or a Triple DES encrypted tunnel. Additionally, each component of the data monitor 136 (e.g., SDA 704, SMA 712, 716) and/or the server 112 (e.g., query processor 408) can be a software module (e.g., task or object) or a hardware device.

Thus, the data monitor 136 includes many components which interact with the components of the customer network 134 (e.g., client 104) to enable the transfer of data only when the security analysis module 144 requests the data. Moreover, the data monitor 136 facilitates multiple query sessions, enabling the security analysis module to properly and accurately analyze the security event. Further, because each customer has its own data monitors 136, the security analysis system's storage of data is not centralized, consequently becoming robust and scalable.

FIG. 7B illustrates an embodiment of the data flow in the data monitor 136. The data monitor 136 can include, for example, a correlation layer 762, an event correlation system 764, a CRM layer 766, a portal 768, and an information layer 770. In one embodiment, the correlation layer 762 includes the event correlation system 764 as well as a centralized SDA 780. The correlation layer 762 can be a language-based correlation engine that can be, e.g., programmed using its language.

The CRM layer 766 can include a remedy module 767 to determine how to remedy the security event. The information layer 770 can include one or more databases 772 having information associated with the security event. The portal 768 can have a portal module 769 providing, for instance, a web-based graphical user interface to display/report information associated with the security event. Moreover, the data monitor 136 can also employ external data 774 in its analysis of the security event. In one embodiment, the description for FIG. 7B and the modules shown in FIG. 7B are part of the SAA 750.

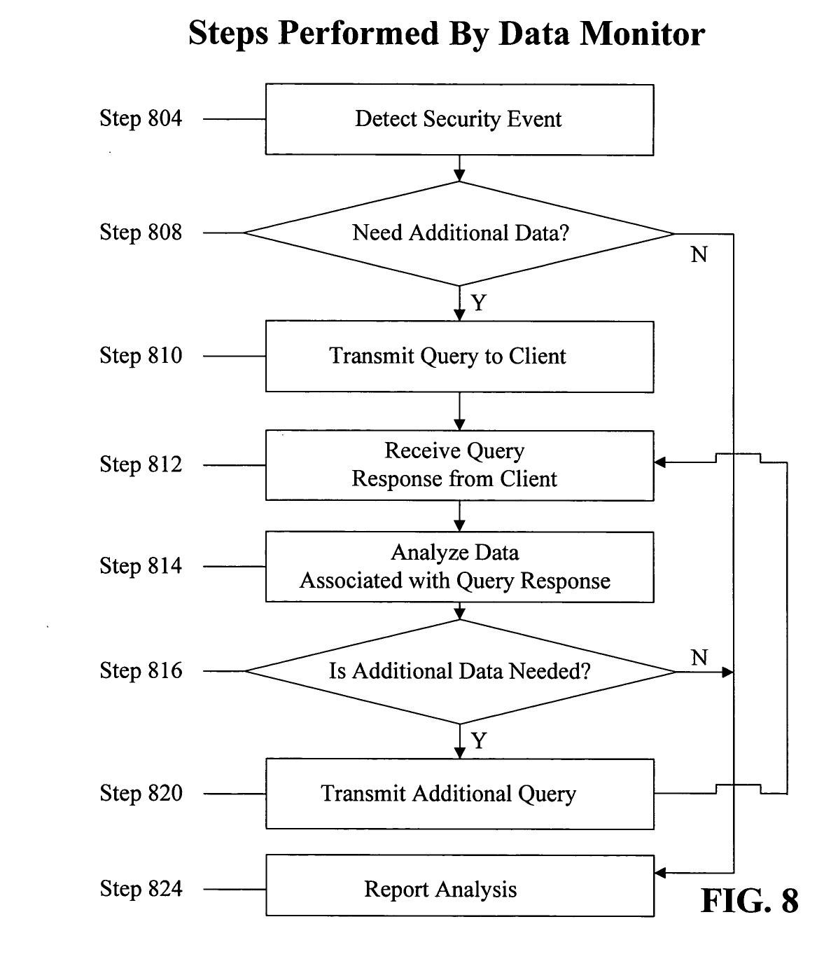

In more detail and also referring to FIG. 8, some or all of the steps performed by the security analysis module 144 can alternatively be performed by the data monitor 136. Thus, the data monitor 136 can monitor the devices in the customer network 134 (e.g., the client 104) to detect an occurrence of a security event (step 804). The data monitor 136 then determines if analysis of the detected security event requires data from one or more components (e.g., the client 104) (step 808). Although described below with respect to the client 104, the description can also apply to any component of the customer network 134. Moreover, the security analysis module 144 or some of the modules of the security analysis module 144 can be located within the customer network 134.

In one embodiment, the data monitor 136 determines that it does need data from the client 104 of the customer network 134 in step 808. The data monitor 136 then transmits a query to the client 104 requesting particular data (step 810). The client 104 receives the query and obtains the data requested. The client 104 then transmits a query response to the data monitor 136. The data monitor 136 receives the query response (step 812) and analyzes the data associated with the query response (step 814).

In some embodiments, the data monitor 136 performs analysis on the data to determine if the data is useful for analyzing the security event. Based on this determination, the data monitor 136 may send the data to the security analysis module 144 or may discard the data (i.e., if found to not be useful).

The data monitor 136 can then determine whether additional data is needed for the analysis of the security event (step 816). If the data monitor 136 determines that additional data is needed, the data monitor 816 transmits one or more additional queries to the client 104 (step 820). The data monitor 136 then repeats steps 812-820 until determining that additional queries are not needed (step 816). The data monitor 136 can also report the results of the analysis (step 824) (at any time throughout these steps). This report can be to the client 104 and/or to the security analysis module 144.

In one embodiment, the invention described above can apply to physical devices. For example, the client 104 (or another device in the customer network 134) can include a door lock, a door badge, a motion detector, a baby monitor, a telephone, an automated teller machine (ATM), credit card processing, a camera, and/or an elevator. Thus, a security event can occur when, for example, the door lock is unlocked, the door badge is duplicated or forged, the motion detector detects motion, the baby monitor detects a sound, the telephone is tapped or rings, the automated teller machine is broken into, the credit card processing processes an incorrect credit card number, an overcharge, or an incorrect transaction (e.g., person enters wrong information (such as expiration date) for a particular credit card number), the camera runs out of film, and/or the elevator changes position.

Additionally, although described above as a security event within a “customer network 134”, the network can alternatively be a single computer system in which the nodes are processes in memory. Thus, a security event can include an attack on a sub-system level. In this embodiment, intruders may be rogue processes.

Although the present invention has been described with reference to specific details, it is not intended that such details should be regarded as limitations upon the scope of the invention, except as and to the extent that they are included in the accompanying claims.

What is claimed is:

1. A method for analyzing a security event in a distributed fashion, comprising:
(a) detecting an occurrence of a security event within a customer network;
(b) querying a first component of the customer network for data in response to the detected occurrence of the security event;
(c) receiving, by a data monitor located within the customer network, first data from the component in response to the query;
(d) determining, based on the received first data, whether to query for additional data;
(e) querying at least one of the first component and another component of the customer network to obtain the additional data in response to the determining step; and
(f) analyzing the security event using at least one of the first data and the additional data.

2. The method of claim 1 wherein step (a) further comprises determining at least one of intrusion of the customer network, a port scan, service probes, a signature from an attack, a buffer overflow attempt, a format string attack, a denial of service attempt, a web-based attack, and an attempted rights escalation.

3. The method of claim 1 wherein step (a) further comprises monitoring the customer network for the security event.

4. The method of claim 1 wherein step (a) further comprises determining at least one of nature of the security event, likelihood that the security event is harmful, and impact of the security event.

5. The method of claim 1 wherein step (a) further comprises detecting, by the data monitor, the occurrence of the security event.

6. The method of claim 1 wherein the security event further comprises a potential security event.

7. The method of claim 1 wherein at least one of the first component and the another component of the customer network further comprises at least one of the data monitor and a client computer.

8. The method of claim 1 wherein step (b) further comprises querying, by the data monitor, the component.

9. The method of claim 1 wherein step (c) further comprises at least one of
(i) transmitting the received first data to a security analysis module for analysis, and
(ii) analyzing the first data.

10. The method of claim 1 wherein step (d) further comprises analyzing the first data to determine whether to query for additional data.

11. The method of claim 1 wherein step (d) further comprises determining, by the data monitor, whether to query for additional data.

12. The method of claim 1 wherein step (f) further comprises populating a trouble ticket during the analysis.

13. The method of claim 1 wherein step (f) further comprises analyzing, by the data monitor, the security event.

14. The method of claim 1 further comprising reporting a result of the analysis.

15. A method for analyzing a security event in a distributed fashion, comprising:
(a) detecting an occurrence of a security event within a customer network;
(b) querying a first component of the customer network for data in response to the detected occurrence of the security event;
(c) receiving, by a data monitor located within the customer network, first data from the component in response to the query;
(d) determining, based on the received first data, whether to query for additional data;
(e) querying at least one of the first component and another component of the customer network to obtain the additional data in response to the determining step; and
(f) analyzing, by the data monitor, the security event using at least one of the first data and the additional data.

16. An apparatus for analyzing a security event within a customer network comprising:
(a) a data monitor, positioned within the customer network, to collect data from at least one component of the customer network in response to a query; and
(b) a security analysis module, in communication with the data monitor, to detect an occurrence of the security event, wherein the security analysis module comprises:
(b-a) a receiver for receiving data from the data monitor,
(b-b) an analyzer, in communication with the receiver, for analyzing the security event, and
(b-c) a querying module, in communication with the analyzer, for querying the data monitor for data repeatedly until the analyzer can analyze the security event using the data.

17. The apparatus of claim 16 wherein the querying module further comprises at least one of a query processor, an analyst, a message router, and a resolver.

18. The apparatus of claim 16 wherein the component further comprises a client located within the customer network.

19. The apparatus of claim 16 further comprising an analyst to at least one of
(i) modify settings of the data monitor in response to at least one of the security event, a query, and the data,
(ii) monitor communications between the data monitor and the security analysis module,
(iii) initiate the query of the data monitor, and
(iv) modify the query of the querying module.

20. The apparatus of claim 16 wherein the security analysis module further comprises at least one of
(b-d) an event repository to store information about the security event,
(b-e) a message router, in communication with the querying module, to direct and receive at least one of queries and the data, and
(b-f) a resolver, in communication with the querying module, to provide a location of at least one of the data monitor and the component to the querying module.

21. The apparatus of claim 20 wherein the resolver further comprises a characteristic table having an attribute of a component in the customer network.

22. The apparatus of claim 21 wherein the attribute of the component further comprises at least one of type of service provided to the component, company that the component resides in, network address of the component, geographic data of the component, security domain of the component, and information of a service level agreement associated with the component.

23. The apparatus of claim 16 further comprising an arbitrator that prioritizes at least one of the security event in a plurality of security events and the data received from the data monitor.

24. The apparatus of claim 23 wherein the arbitrator further comprises at least one of
(i) a threat analysis engine analyzing the security event based on a parameter of the security event to determine importance of the security event,
(ii) a business asset analysis engine determining an impact of the security event if left unresolved; and
(iii) a service level management engine determining steps needed to resolve the security event.

25. The apparatus of claim 24 wherein the parameter of the security event further comprises at least one of amount of time elapsed since the occurrence of the security event, duration of time of the security event, number of previous occurrences of the security event, communication protocol, and type of security event.

26. The apparatus of claim 24 wherein the impact determined by the business asset analysis engine further comprises at least one of a down time that a component of the customer network may experience in response to the security event, costs associated with the down time, and estimated man-hours to resolve the security event.

27. The apparatus of claim 24 wherein the steps needed to resolve the security event further comprise determining a resolution time for the security event.

28. The apparatus of claim 16 wherein at least one of the security analysis module, the receiver, the analyzer, and the querying module are located on the customer network.

29. The apparatus of claim 16 wherein the data monitor further comprises at least one of
(i) a security defense appliance monitoring the customer network,
(ii) a security management appliance, in communication with the security defense appliance, receiving a query from the querying module and directing the query to the security defense appliance, and
(iii) a security analysis appliance analyzing the data.

30. An apparatus for analyzing a security event within a customer network comprising:
(a) a data monitor, positioned within the customer network, to collect data from the customer network; and
(b) a security analysis module, in communication with the data monitor, to determine an occurrence of the security event;
(c) a receiver for receiving data from the data monitor,
(d) an analyzer, positioned within the customer network, for analyzing the security event, and
(e) a querying module, in communication with the analyzer, for querying the data monitor for data repeatedly until the analyzer can analyze the security event using the data.

31. The apparatus of claim 30 wherein the data monitor further comprises at least one of
(i) a security defense appliance monitoring the customer network,
(ii) a security management appliance, in communication with the security defense appliance, receiving a query from the querying module and directing the query to the security defense appliance, and
(iii) a security analysis appliance analyzing the data.

32. The apparatus of claim 32 wherein the analyzer further comprises the security analysis appliance.

33. The apparatus of claim 31 wherein at least one of the security analysis module, receiver, and querying module are located within the customer network.
